(19) United States
(12) Patent Application Publication
(10) Pub. No.: US 2011/0149014 A1
(43) Pub. Date: Jun. 23, 2011

(54) COMMUNICATION DEVICE AND PRIVACY PROTECTION METHOD

(75) Inventor: WEN-CHING CHUNG, Tu-Cheng (TW)

(73) Assignee: FOXCONN COMMUNICATION TECHNOLOGY CORP., Taoyuan County (TW)

(21) Appl. No.: 12/770,763

(22) Filed: Apr. 30, 2010

(30) Foreign Application Priority Data
Dec. 18, 2009 (CN) 200910311813.1

(51) Int. Cl. H04N 7/14

(52) U.S. Cl. 348/14.12; 348/E07.078

(57) ABSTRACT

A communication device and a privacy protection method receives an incoming call from a remote communication device, and transmits a preset substitute image to the remote communication device if a user of the communication device declining to share live video images with the remote user. When the user answers the incoming call, the method can check with the user as to determine whether to connect a live video. If the user of the communication device responds to include video, the method connects the video and transmit live video images to the remote communication device synchronously with voice communication of the call.

### BACKGROUND

1. Technical Field

Embodiments of the present disclosure generally relate to a communication device, and more particularly to a privacy protection method for use during a video call made with the communication device.

2. Description of Related Art

Communication devices that allow making of video calls are becoming more common nowadays. However, if a user is not careful, private activities or information may be inadvertently revealed during the video calls.

What is needed, therefore, is a privacy protection method for use during a video call of a communication device, to overcome the aforementioned problems.

### BRIEF DESCRIPTION OF THE DRAWINGS

FIG. 1 is a block diagram of one embodiment of a communication device for privacy protection during a video call.

FIG. 2 is a block diagram of function modules of a privacy unit included in the communication device of FIG. 1.

FIG. 3 is a flowchart illustrating one embodiment of a privacy protection method for use during a video call of the communication device.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

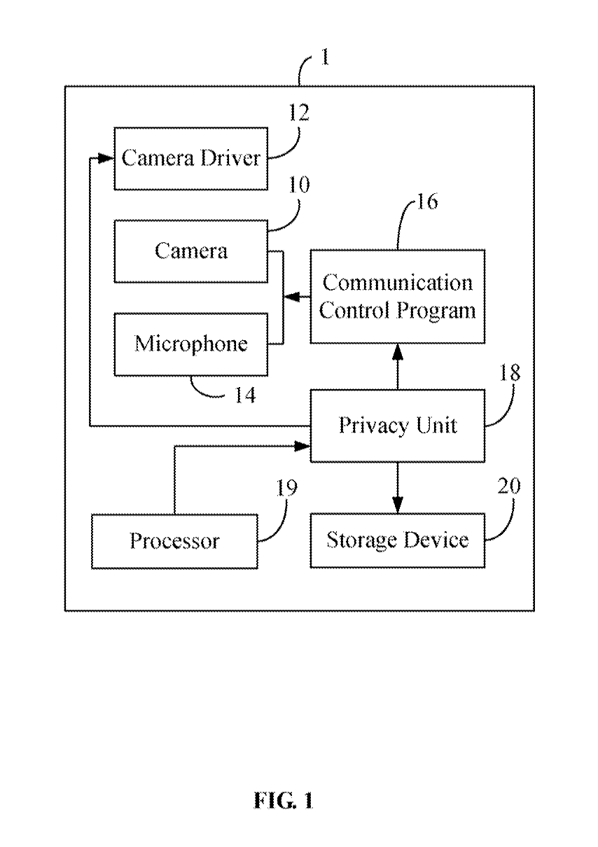

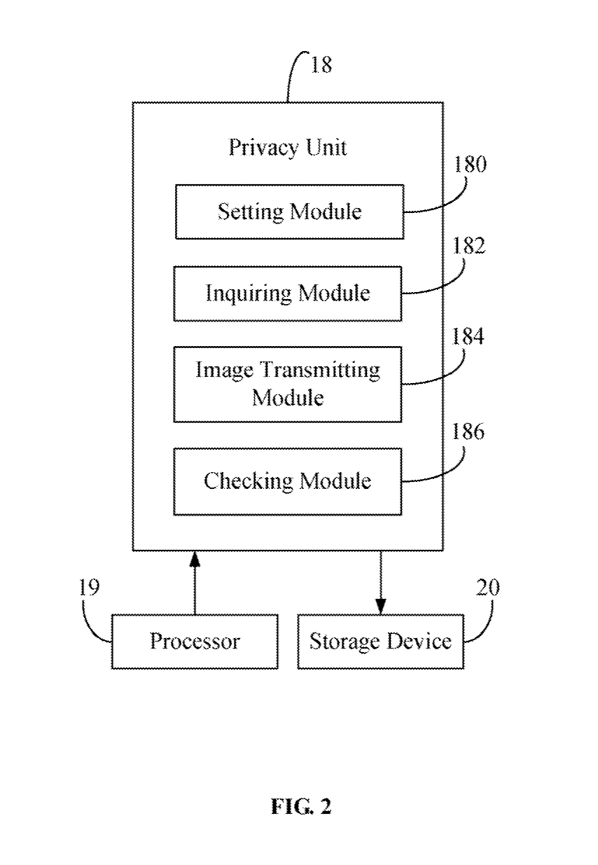

FIG. 1 is a block diagram of one embodiment of a communication device 1 that can be used for privacy protection during a video call. The communication device 1 may be a mobile phone, or a video phone that supports video calls. The phone 1 typically includes a camera 10, a camera driver 12, a microphone 14, a communication control program 16, and a privacy unit 18. The camera driver 12, and one or more computerized codes of the program 16 are stored in a storage device 20 (see in FIG. 2). In one embodiment, the storage device 20 may be installed in the phone 1 or be externally connected with the phone 1, the storage device 20 may be a random-access memory (RAM), a read-only memory (ROM), or a flash memory, for example.

The camera driver 12 drives the camera 10 to capture images (including video images) or make a video call with other communication devices. The program 16 can be configured for controlling the captured images or video data to be transmitted to the other communication devices, and controlling voice transmission via the microphone 14. The privacy unit 18 is configured for protecting the privacy of a user during a video call of the phone 1.

FIG. 2 is a block diagram of function modules of the privacy unit 18 included in the phone 1. In one embodiment, the privacy unit 18 may include one or more computerized instructions or codes that are stored in the storage device 20 and can be executed by the at least one processor 19. In another embodiment, the camera driver 12 or the program 16 can include the privacy unit 18.

As illustrated in FIG. 2, the privacy unit 18 may include a setting module 180, an inquiring module 182, an image transmitting module 184, and a checking module 186.

The setting module 180 stores a preset substitute image, such as a still image of a user, in the phone 1. In one embodiment, the substitute image is stored in the camera driver 12 or in the program 16.

When the phone 1 receives an incoming call from a remote communication device (e.g., another phone or electronic device), the inquiring module 182 generates a dialog box displayed on a screen of the phone 1, to prompt the user to decide whether to conduct a live video or to use the substitute image displayed on the remote communication device instead to protect their privacy. The image transmitting module 184 may transmit the preset substitute image to the remote communication device through a wireless network when this option is selected. In the embodiment, it assumed that the remote communication device supports video calls.

When the phone 1 answers the incoming call, the phone 1 is initially in a voice only mode, so the checking module 186 then checks with the user of the phone 1 as to determine whether to connect live video as well. For example, the checking module 186 generates a dialog box displayed on the phone 1 that is accompanied by a speech sound, to prompt the user whether to connect the live video according to a preset time interval, such as one or two seconds.

If the user of the phone 1 responds to the prompt to include video, the checking module 186 activates the camera driver 12 to drive the camera 10 to capture live video images, and the image transmitting module 184 transmits the live video images to the remote communication device synchronously with the voice communication.

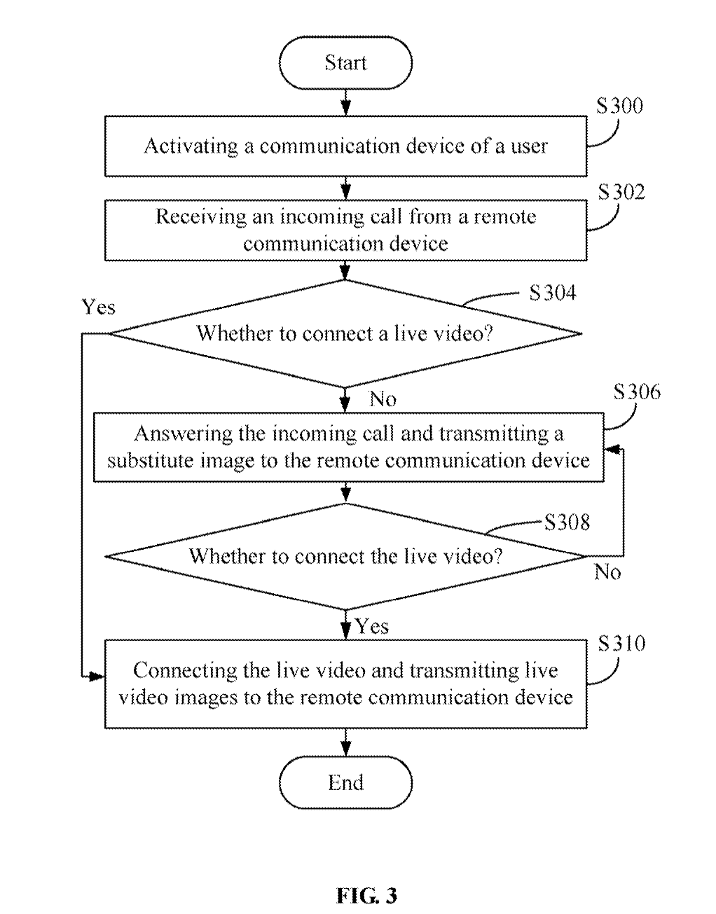

FIG. 3 is a flowchart illustrating one embodiment of a privacy protection method for a user during a video call made with the communication device 1.

In block S300, the communication device 1 is activated. In the embodiment, the communication device 1 supports video calls.

In block S302, the communication device 1 receives an incoming call from a remote communication device. In the embodiment, the remote communication device also supports video calls.

When the communication device 1 answers the incoming call, in block S304, the inquiring module 182 generates a dialog box displayed on a screen of the phone 1 to prompt the user to choose whether to connect a live video. If, for example, it is not convenient for the user to share live video images with the remote user, the user choose no and the flow enters block S306. Otherwise, the user chooses yes, and the flow enters block S310.

In block S306, the program 16 controls the communication device 1 to make a voice communication with the remote communication device, namely answering the incoming call, and the image transmitting module 184 transmits the preset substitute image to the remote communication device, and the preset substitute image may be displayed on the remote communication device. In one embodiment, the preset substitute image is stored in the camera driver 12 or in the program 16.

During the communication device 1 answers the incoming call, in block S308, the checking module 186 checks with the user of the communication device 1 as to determine whether to connect the live video of the communication device 1. If the user of the communication device 1 responds to include video, the flow enters block S310. Otherwise, if the user of the communication device 1 does not respond to include video, namely the user does not want to share live video images with the remote user, the flow goes back to block S306, and voice communication with the remote user is available, and the image transmitting module 184 transmits the preset substitute image to the remote communication device.

In block S310, the checking module 186 connects the live video of the communication device 1, and the camera driver 12 drives the camera 10 to capture live video images, and the program 16 controls the communication device 1 to transmit the live video images to the remote user synchronously with the voice communication of the call.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for privacy protection during a video call of a communication device, the method comprising:
receiving an incoming call from a remote communication device that supports video calls;
answering the incoming call and transmitting a preset substitute image to the remote communication device, in response to a user of the communication device declining to share live video images with a user of the remote communication device;
checking with the user of the communication device as to determine whether to connect a live video of the communication device when the communication device answers the incoming call;
connecting the live video of the communication device, upon a condition that the user of the communication device responds to include video; and
capturing live video images by a camera of the communication device and transmitting the live video images to the remote communication device synchronous with voice communication of the incoming call.

2. The method as described in claim 1, wherein the preset substitute image is stored in a communication control program of the communication device.

3. The method as described in claim 1, wherein the preset substitute image is stored in a camera driver of the communication device.

4. The method as described in claim 1, wherein the communication device checks the user using a voice warning system or a message system.

5. A storage medium having stored thereon instructions that, when executed by a processor of a communication device, causes the processor to implement a privacy protection method during a video call made with the communication device, the method comprising:
receiving an incoming call from a remote communication device that supports video calls;
answering the incoming call and transmitting a preset substitute image to the remote communication device, in response to a user of the communication device declining to share live video images with a user of the remote communication device;
checking with the user of the communication device as to determine whether to connect a live video of the communication device when the communication device answers the incoming call;
connecting the live video of the communication device, upon a condition that the user of the communication device responds to include video; and
capturing live video images by a camera of the communication device and transmitting the live video images to the remote communication device synchronous with voice communication of the incoming call.

6. The storage medium as described in claim 5, wherein the preset substitute image is stored in a communication control program of the communication device.

7. The storage medium as described in claim 5, wherein the preset substitute image is stored in a camera driver of the communication device.

8. The storage medium as described in claim 5, wherein the communication device checks the user by using a voice warning system or a message system.

9. A communication device, comprising:
at least one processor;
a storage device; and
a privacy protection unit stored in the storage device and executed by the at least one processor, the privacy unit comprising:
an image transmitting module operable to transmit a preset substitute image to a remote communication device after receiving an incoming call from the remote communication device, in respond to a user of the communication device declining to share live video images with a user of the remote communication device;
a checking module operable to check with the user whether to connect the live video of the communication device when the user answering the incoming call, and connect the live video of the communication device if the user of the communication device responds to include video; and
the image transmitting module further operable to transmit live video images captured by a camera of the communication device to the remote communication device synchronously with voice communication of the incoming call.

10. The communication device as described in claim 9, further comprising:
an inquiring module operable to generate a dialog box displayed on the communication device to prompt the user to decide whether to connect a live video or to use the substitute image instead to protect privacy, after receiving the incoming call from the remote communication device.

11. The communication device as described in claim 9, wherein the checking module checks the user using a voice warning system or a message system.

12. The communication device as described in claim 9, wherein the privacy unit further comprises a setting module operable to store the preset substitute image in the communication device.

13. The communication device as described in claim 12, wherein the preset substitute image is stored in a communication control program of the communication device.

14. The communication device as described in claim 12, wherein the preset substitute image is stored in a camera driver of the communication device.

15. The communication device as described in claim 9, wherein the communication device is a mobile phone, or a video phone.
